(19) United States
(12) Patent Application Publication
(10) Pub. No.: US 2003/0164646 A1
(43) Pub. Date: Sep. 4, 2003

(54) Neon light sparkplug wire

(76) Inventor: Winston D. Tooke, Gainesville, FL (US)

Correspondence Address: Winston D. Tooke, 6906 SW 91st. Terrace, Gainesville, FL, 32608, US

(21) Appl. No.: 10/375,473

(22) Filed: Feb. 27, 2003

Related U.S. Application Data
(60) Provisional application No. 60/360,228, filed on Mar. 1, 2002.

(51) Int. Cl. H02J 7/00

(52) U.S. Cl. 307/150

(57) ABSTRACT

The neon light sparkplug wire is a sparkplug wire that has been separated or formed into two pieces and joined back together using a neon light tube. When installed to any motor using a sparkplug, the neon light lights up each time the source of spark provides a spark through the completed assembly to the sparkplug.

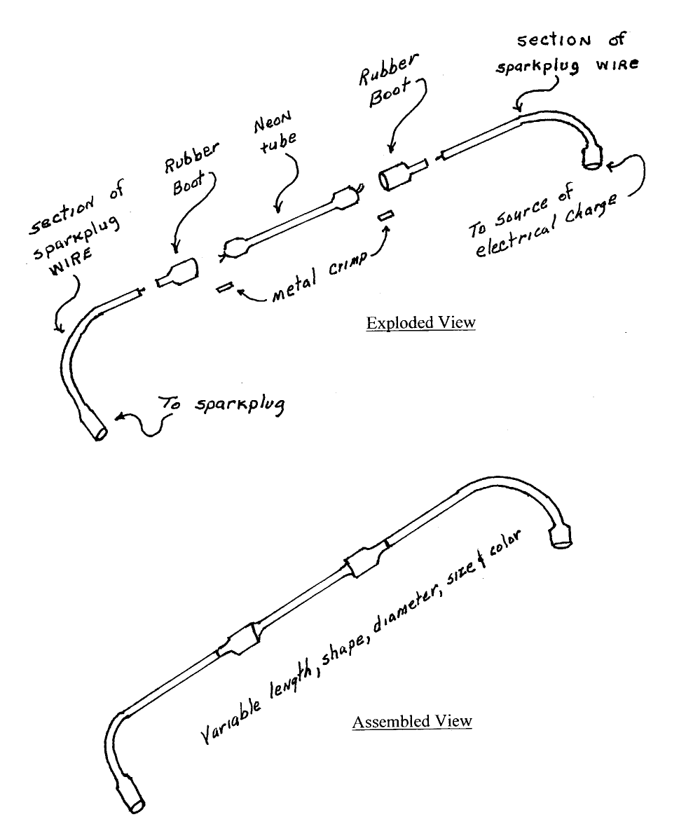

### CROSS-REFERENCE TO RELATED ACTIVITIES

This application claims the benefit of U.S. Provisional Patent Application No. 60/360,228 filing date of Mar. 1, 2002.

### STATEMENT REGARDING FEDERALLY SPONSORED RESEARCH OR

DEVELOPMENT Not Applicable

### REFERENCE TO SEQUENCE LISTING

Not Applicable

### BACKGROUND OF THE INVENTION

The use of neon lighting in and on motorized vehicles has become very popular for aesthetics and safety. Present use of neon lights on motorized vehicles operate from the electrical current provided by a battery plus additional apparatus to light the neon light. This invention utilizes a neon light as a functioning part of a sparkplug wire. The neon light sparkplug wire utilizes the existing electrical charge coming from a distributor to the sparkplug. It may be used on any internal combustion engine utilizing one or many sparkplugs.

### SUMMARY

The neon light sparkplug wire utilizes existing electrical current provided by a motorized vehicle utilizing one or many sparkplugs. It illuminates the area around the neon light in the colors desired. It may be constructed in various shapes and sizes depending on the desire of the user.

### DESCRIPTION OF DRAWING

The one page drawing illustrates an exploded view at the top of the page and a constructed view at the bottom of the page.

### DETAILED DESCRIPTION OF THE INVENTION

The neon light sparkplug wire is a sparkplug wire that has been separated or formed into two pieces and joined back together using a neon light tube. When installed to any motor using a sparkplug, the neon light lights up each time the source of spark provides a spark through the completed assembly to the sparkplug.

The sparkplug wire is cut or formed into two pieces. Approximately one inch of each of the cut ends is stripped of the outer coatings to expose the conductive portion of the sparkplug conductive material.

Slide a rubber boot over each end of the cut or formed sparkplug wire.

Twist-tie one end of the neon tube wire to one end of the stripped sparkplug wire or manufactured wire and install a crimp to secure the union. Repeat this operation to the other end. If using a solid core sparkplug wire the union may be soldered.

Slide the rubber boots on the sparkplug wire over the union and onto the ends of the neon light tube until they seat firmly on the neon tube.

The assembly or neon sparkplug light is ready for installation on a motor. Depending on its length and shape, the assembly may be secured by many methods and in several locations.

What I claim as my invention is:

1. A circuit utilizing a neon light tube between the source of power and a sparkplug on an internal combustion motor.

2. The circuit of claim 1 is comprised of at least one neon light tube with a conductive led attached to each end where:
a. One led accepts electrical charge from a distributor or source of power and transfers the charge through the neon light tube through the other led.
b. The other led discharges the electrical charge to a sparkplug.
